(19) United States
(12) Patent Application Publication
(10) Pub. No.: US 2014/0317229 A1
(43) Pub. Date: Oct. 23, 2014

(54) Automatic versioning and updating M2M network applications

(71) Applicants: Robbin Hughes, Plano, TX (US); Thomas O'Neill, La Jolla, CA (US); Prem Jothipragasam Kumar, San Diego, CA (US); Ramesh Rajasekaran, Chennai (IN)

(72) Inventors: Robbin Hughes, Plano, TX (US); Thomas O'Neill, La Jolla, CA (US); Prem Jothipragasam Kumar, San Diego, CA (US); Ramesh Rajasekaran, Chennai (IN)

(21) Appl. No.: 13/868,489

(22) Filed: Apr. 23, 2013

(51) Int. Cl. H04L 29/08

(52) U.S. Cl. CPC H04L 67/34
USPC 709/217; 709/223

(57) ABSTRACT

The proposed embodiment provides a method and system for automatically versioning machine to machine (M2M) network applications. The method and system includes receiving information about applications associated with each node in the network, determining new versions of the applications based on the received information and versioning the new versions of the applications on each node in the network.

### TECHNICAL FIELD

The embodiments herein relate to network management systems and, more particularly, for automatically versioning of machine to machine (M2M) applications in a M2M network management system.

### BACKGROUND

Modern machine to machine (M2M) networks generally provide an environment where different types of devices are connected through the Internet to virtually share any type of information. The devices generally include different types of software applications deployed thereon for automatic flow of information and management of the devices. Such software applications often need to be updated (and/or upgraded) as new versions, improvements, features, functionalities, or bug fixes are released. Updating the software applications on the devices involve significant challenges.

Different methods and systems are proposed for updating the software applications for the devices. The existing systems and methods include updating each individual device software applications, which may involve manual or semi-manual interventions. Further, the software applications configured with automatic application update and activation features can be provided to the devices. The existing systems and methods are effective in updating the software applications of the devices, but include both advantages and disadvantages in terms of time, cost, version, compatibility, synchronization, and performance based on different versions of the software applications running on the devices.

### BRIEF DESCRIPTION OF THE FIGURES

The embodiments herein will be better understood from the following detailed description with reference to the drawings, in which:

FIG. 1 illustrates generally, among other things, a system in which the present embodiment is embodied, according to embodiments described herein;

FIG. 2 expands features and functions of the system as described in the FIG. 1, according to embodiments described herein;

FIG. 3 is an example platform of M2M network system, according to embodiments described herein; and

FIG. 4 is a flowchart illustrating generally a method for automatically versioning M2M network applications, according to embodiments disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose a method and system for automatically versioning machine to machine (M2M) network applications. A central server can be configured to monitor the information about one or more applications associated with one or more nodes in the M2M network. The server includes network analysis tools to analyze the information about the nodes to determine new versions (and/or updates) of the applications. The determined versions (and/or updates) of the applications can be automatically downloaded and installed on each node of the network. The server can automatically restart each node to activate the new versions (and/or updates). Further, the server can provide versions (and/or updates) which are configured to automatically activate associated service(s) on each node in the M2M network.

The proposed system and method is simple, reliable, and robust for automatically versioning/upgrading and updating M2M network applications. The system and method can be used to evaluate and synchronize network applications versions and automatically download, install, and update/upgrade applications associated with each node in the M2M network. Error-free, fast, synchronous, and inexpensive updates/upgrades can be performed for each node in the M2M networks. Further, the system and method can be used to increase performance, availability of resources, and improve efficiency of network applications management with significantly less cost and time. Administrators can easily use various versions of the network applications in simulation to provide optimal solutions to customers.

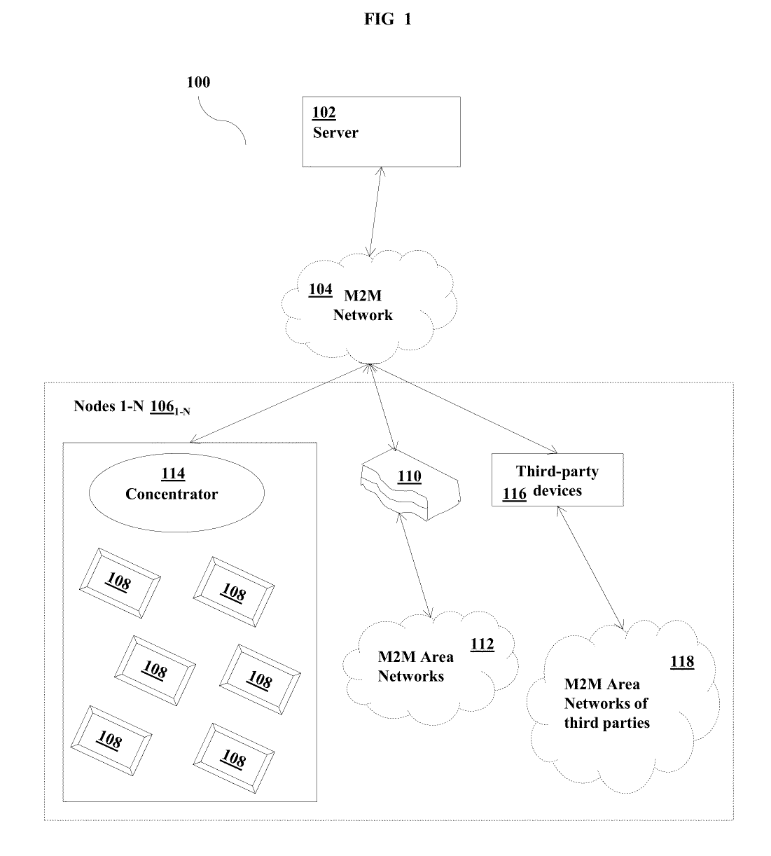

Referring now to the drawings, and more particularly to FIGS. 1 through 4, where similar reference characters denote corresponding features consistently throughout the figures, there are shown embodiments.

Throughout the description the term “versioning (or version)” and “upgrading (or upgrade)” is used interchangeably.

FIG. 1 illustrates generally, among other things, a system 100 in which the present embodiment is embodied, according to embodiments described herein. The system 100 can provide a complete solution including a server 102 (also referred as M2M server 102), M2M network(s) 104, and a plurality of nodes 106_{1-N} (hereafter referred as nodes 106). The nodes 106 described herein can include for example, but not limited to, M2M devices (for example, the devices 108), M2M gateways (for example, the gateway 110) and associated networks (for example, the M2M area network 112), concentrators (for example, the devices 114), third-party service providers (for example, the third-party devices 116) and associated networks (for example, the M2M area networks of third-parties 118), and various other networks sources (not shown) such as routers, hubs, collectors, sensors, meters, back-up server(s), storage devices, and the like. In an embodiment, the M2M network(s) 104 described herein can include for example, but not limited to, wireless network, wire line network, cellular network, personal network, private network, public network such as the Internet, local area network (LAN), wide area network (WAN), metropolitan area network (MAN), global system for mobile communications (GSM) network, or a combination thereof.

In an embodiment, each node in the M2M network 104 can be configured to include one or more applications (hereafter referred as applications interchangeably) to enable communication among the nodes 106 in the network 104. In an embodiment, the applications described herein can include for example, but not limited to, network software components, patches, add-ins, plug-ins, configuration files, or any other applications capable of allowing the nodes to share, control, manage, interact, communicate, and control data among the nodes 106 in the M2M network 104.

In an embodiment, the server 102 can be configured to capture information about applications associated with the nodes 106 over the M2M network 104. The information captured by the server 102 can include for example, but not limited to, applications installed on each node, different versions of applications used by each node, version number, last update time and date, and the like. Further, the server can be configured to collect other information associated with each node such as for example, but not limited to, each node IP address, MAC address, changes in network states such as new nodes registering, nodes unregistering, node paths changing, traffic associated with the nodes, multiple routes and paths associated with each node, and the like. The captured information is maintained by the server 102. In an example, retrieving information associated with the nodes 106 can involve privacy concerns, such as transmitting the information of the nodes 106 over the M2M network 104 (or any third-party applications, devices, and networks). Options are available to address privacy concerns. The options may include that an administrator or security applications may be chosen to opt-in to participate or to opt-out to not participate in monitoring or sharing of the information associated with the nodes 106.

Further, the server 102 can be configured to include or coupled to one or more databases describing current versions of applications information associated with each node and the historical versions of applications associated with each node in the M2M network. The historical versions of applications information of the system 100 can be used to restore the network applications at any particular point.

In an embodiment, hierarchical integration of the system 100 can allow functionality to reside closer to involved nodes, while at the same time enabling optimizations in synchronizing the versions of applications installed thereon. In an embodiment, the nodes and the network applications information can be mirrored, shared, or coordinated within the system 100 so as to alleviate the network performance.

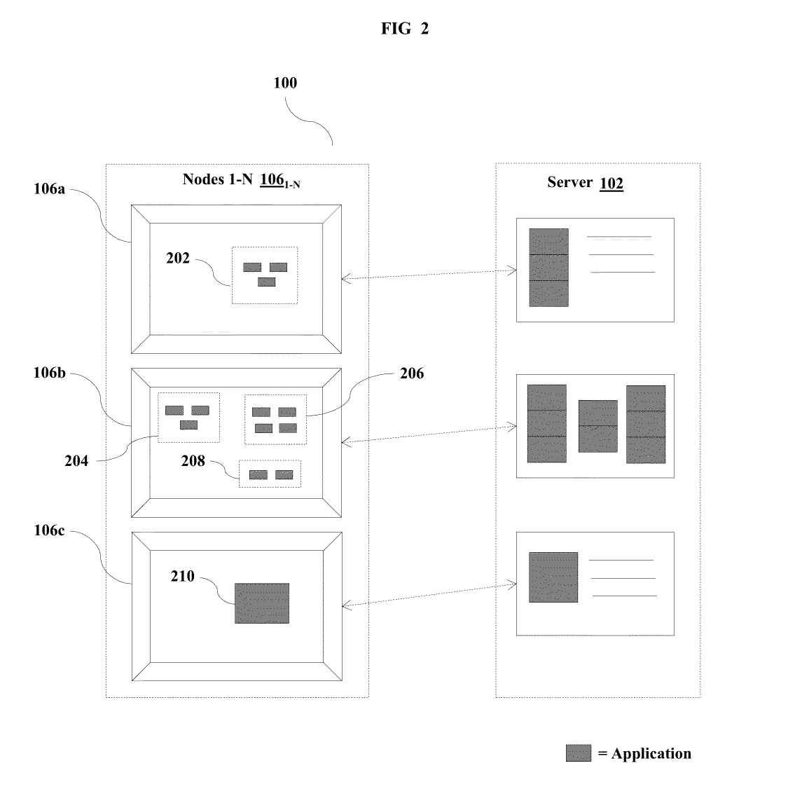

FIG. 2 expands features and functions of the system 100 as described in the FIG. 1, according to embodiments described herein. In an embodiment, the server 102 can be configured to collect the information about one or more applications associated with each node in the M2M network 104. The server 102 can be configured to use network analysis tools to analyze the collected information and provide appropriate upgrades (and/or updates) for the applications installed on each node in the M2M network 104.

As shown in the FIG. 2, each node in the network can include different versions of the same application providing different services, features, functions, and benefits to the user. For example, the node 106a includes three different versions of same application as shown at 202. Each version may be used by the node in different way to access services available in the network. Similarly, the node 606b includes three versions of an application as shown at 204, four versions of another application as shown at 206, and two versions of yet another application as shown at 208. In another example, the node 606c includes only one version of an application as shown at 210.

In an embodiment, the server 102 can be configured to receive information about the application associated with each node in the network. An appropriate versions of the applications can be evaluate and synchronize based on the received information. The server 102 can be configured to use the network analysis tools to determine appropriate, compatible, and synchronized versions (and/or updates) for the applications. The server 102 can be configured to include total control over the applications and associated operations performed on the nodes 106. Further, the server 102 can be configured to manage and maintain the configuration of the applications, links associated among the nodes 106, the nodes 106 status information, services offered by each version of applications, services used by each node, and the like to evaluate and synchronize appropriate applications for each node in the network 104. The server 102 can be further configured to continuously monitor applications to provide associated updates (and/or updates) and optimize the M2M network 106, such as to increase the network performance, availability of resources, and decrease the network maintenance cost.

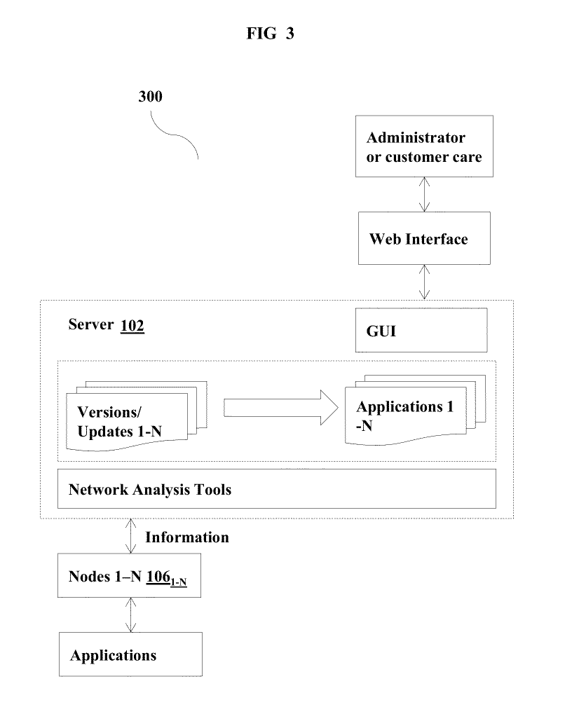

FIG. 3 is an example platform 300 of the M2M network system 100, according to embodiments described herein. In an embodiment, the server 102 can be configured to implement or include network analysis tools to analyze the collected information. The tools can be configured to produce a ready-to-run deliverable that can be compatible and synchronized with the applications associated with the nodes 106. In an embodiment, the server 102 can be configured to include information about the different versions (and/or updates) associated with the network applications. In an embodiment, the server 102 can be configured to store different services and features offered by different versions of the applications, such as to determine appropriate versions and updates for each node in the network. In an embodiment, the network analysis tools can be configured to determine same versions/updates of the application for each node in the network or can determine different versions/updates of the application for each node in the network. The server 102 can be configured to determine appropriate versions/updates for each node based on the services and features offered by different versions of applications and the services utilized by each node in the network.

Furthermore, the server 102 can be configured to include or implement Graphical User Interface (GUI) to provide a standard and easy-to-use web interface to the administrator (or customer care, network analyst, or any other user). The web interface can be configured to display current update status and versioning/upgrading information about each node in the network. Furthermore, the administrator can use web interface to manage the updates, applications, versions, and the like information associated with each node in the M2M network 104.

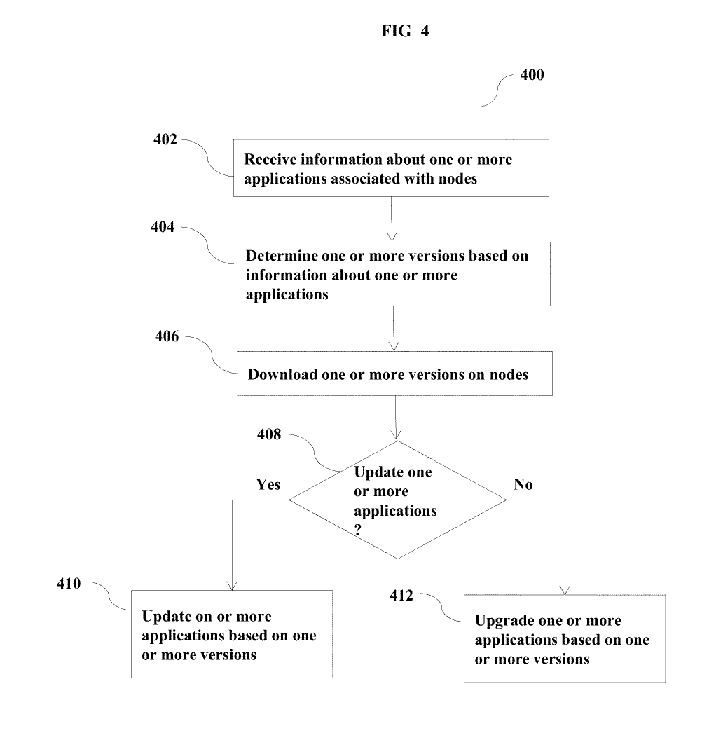

FIG. 4 is a flowchart illustrating generally a method 400 for automatically versioning M2M network applications, according to embodiments disclosed herein. In an embodiment, at 402, the method 400 includes receiving information about one or more applications associated with the nodes 106. In an example, the method 400 allows the server 102 to send a request to each individual node in the M2M network 104 to receive information about the applications associated with the nodes 106. The information captured by the server 102 can include for example, but not limited to, applications installed on each node, different versions of applications used by each node, version(s) number, last update time and date, and the like. Further, the server 102 collects other information associated with each node such as for example, but not limited to, each node IP address, MAC address, changes in network states such as new nodes registering, nodes unregistering, node paths changing, traffic associated with the nodes, multiple routes and paths associated with each node, and the like.

In an embodiment, at 404, the method 400 includes determining one or more versions based on the received information. In an example, the method 400 allows the server 102 to use the network analysis tools to evaluate the versions of the applications present on each node. For example, only one version of an application may be present in a node, three versions of same application may be present in the node, or the like. Compatible and synchronous versions (and/or updates) can be determined by the server 102 based on the received information. In an example, the network analysis tools can determine same versions (and/or updates) of the applications for each node in the network or can determine different versions (and/or updates) of the applications for some or all the nodes in the network. Depending on the services and features offered by different versions of applications and the services utilized by each node in the network, the server 102 determines the appropriate, compatible, and synchronous versions (and/or updates) of the applications.

In an embodiment, at 406, the method 400 includes downloading the one or more versions on the nodes 106. In an example, in response to determining that new versions (and/or updates) for the nodes 106, the method 400 allows the server 102 to automatically download the determined versions (and/or updates) on each node.

In an embodiment, at 408, the method 400 includes determining whether to update the existing applications associated with the nodes 106 or upgrade the new versions as a new application on the nodes 106. In an example, the method 400 allows the server 102 to determine update or upgrade the new version applications as a separate application on some or all the nodes of the network.

In an embodiment, at 410, the method 400 includes updating the applications associated with each node based on the downloaded versions (and/or updates) of the applications. In an example, the method 400 allows the server 102 to automatically install and update the existing applications. In an example, the existing application may be edited or new instructions may be inserted in the existing application program to update the existing applications. Further, the server 102 can automatically restart the node to activate the new updates or the server 102 may configure the updates in way to get activated automatically after installation.

In an embodiment, at 412, the method 400 includes upgrading the one or more applications associated with each node based on the one or more downloaded versions. In an example, the method 400 allows the server 102 to automatically install the download version application on the nodes. The new version application can be installed as a standalone application thereby retaining the existing applications unchanged. The new version application can be considered as a latest version and included in trend of application versions available on each node.

The various steps, acts, blocks, units, and actions of the method 400 may be performed in the order presented, in a different order or simultaneously. Further, in some embodiments, some steps, acts, blocks, units, and actions listed in the FIG. 4 may be omitted, added, or skipped without departing from the scope of the embodiment.

The embodiments disclosed herein can be implemented through at least one software program running on at least one hardware device and performing network management functions to control the network elements. The network elements shown in FIGS. 1 through 4 include blocks which can be at least one of a hardware device, or a combination of hardware device and software module.

The embodiment disclosed herein specifies a system for automatically generating machine to M2M network applications. The mechanism allows receiving the network information and automatically generating graphical user interface, a visual representation, and application configurations for each node in the network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of device which can be programmed including e.g. any kind of computer like a server or a personal computer, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the embodiment may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims as described herein.

What is claimed is:

1. A method for automatically versioning machine to machine (M2M) network applications, the method comprising:
receiving information about at least one application associated with at least one node in said network;
determining at least one version of said at least one application based on said information; and
versioning said at least one version of said at least one application on said at least one node in said network.

2. The method of claim 1, wherein said method further comprises communicating at least one request to receive said information from said at least one node in said network.

3. The method of claim 1, wherein said method further comprises downloading said at least one version on said at least one node in said network.

4. The method of claim 1, wherein said method further comprises installing said at least one version on said at least one node in said network.

5. The method of claim 1, wherein said method further comprises updating said at least one application in accordance to said at least one determined version.

6. The method of claim 1, wherein said method further comprises generating at least one version of said at least one application based on said information.

7. A system for automatically versioning machine to machine (M2M) network applications, the system comprising a server configured to:
receive information about at least one application associated with at least one node in said network,
determine at least one version of said at least one application based on said information, and
upgrade said at least one version of said at least one application on said at least one node in said network.

8. The system of claim 7, wherein said server is further configured to communicate at least one request to receive said information from said at least one node in said network.

9. The system of claim 7, wherein said server is further configured to download said at least one version on said at least one node in said network.

10. The system of claim 7, wherein said server is further configured to install said at least one version on said at least one node in said network.

11. The system of claim 7, wherein said server is further configured to update said at least one application in accordance to said at least one determined version.

12. The system of claim 7, wherein said server is further configured to generate at least one version of said at least one application based on said information.
